(19) United States
(12) Patent Application Publication
(10) Pub. No.: US 2019/0067966 A1
(43) Pub. Date: Feb. 28, 2019

(54) CHARGING DOCK WITH INTERCHANGEABLE ADAPTERS

(71) Applicant: BOL, INC, Sunnyvale, CA (US)

(72) Inventor: XIANG ZHANG, SUNNYVALE, CA (US)

(73) Assignee: BOL, INC, SUNNYVALE, CA (US)

(21) Appl. No.: 15/691,754

(22) Filed: Aug. 31, 2017

(51) Int. Cl. H02J 7/00; H02J 7/02

(52) U.S. Cl. CPC H02J 7/0044; H02J 7/022; H02J 2007/0062; H02J 7/007; H02J 7/0054

(57) ABSTRACT

A charging dock capable of charging portable electronic devices with a wide variety of charging ports and charging protocols, such as USB, lightning, and other proprietary protocols, while eliminating the need for separate charging cords. Interchangeable charging adapters can be placed stably on the charging dock, thus providing the necessary charging interface for different portable electronic devices, which can then be placed directly on the charging dock.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

Embodiments of the invention are generally related charging docks, and are particularly related to a charging dock for charging one or more portable electronic devices with different charging ports by utilizing a variety of adapters.

### INTRODUCTION

Generally described, charging docks provide physical platforms where portable electronic devices, such as mobile phones, tablet computers, eReaders, pocket music or video players, and portable gaming consoles, can be conveniently placed and recharged.

Charging docks vary widely in design and implementation. One of the major issues in conventional charging dock designs is that the portable electronic devices, which the docks are designed to hold and charge, evolve rapidly in their charging technology, charging interfaces, and physical shape, rendering the charging docks obsolete in the process. Some charging dock designs attempt to address this by incorporating limited adaptability at the physical charging interface.

Griffin (U.S. Pat. No. 8,115,451) describes a multiple device charging dock, wherein the charging dock provides cavities to support portable devices. The cavities can be fitted with different adapters which different physical dimensions so that the dock can hold devices of different dimensions.

However, such design only offers accommodation for portable devices of different dimension, to a limited extent. It does not provide a charging dock that can accommodate different charging interfaces or protocols, and thus the charging dock still remains very limited in the number of device types it can support.

A second approach has been a “USB hub” type of charger, wherein a charging station only provides a number of powered USB receptacles. A user may plug different types of charging cords into the hub to accommodate a wide range of devices. While more flexible, such design is less aesthetically appealing and convenient than a cordless charging dock. The cords soon become chaotically entangled and are also prone to accidentally unplugging.

What is needed is an aesthetically appealing charging dock that can flexibly interface with a wide range of different devices with different protocols and charging ports, with the ability to accommodate future charging ports that have not yet materialized.

### BRIEF DESCRIPTION OF THE FIGURES

FIG. 1 illustrates a perspective view of a charging dock.

FIG. 2 illustrates a perspective view of a charging dock with portable electronic devices placed thereon.

FIG. 3 illustrates another perspective view of a charging dock with portable electronic devices placed thereon.

FIG. 4 illustrates a cross-section view of a charging dock with portable electronic devices placed thereon.

FIG. 5 illustrates a cross-section view of a charging dock with portable electronic devices placed thereon, with a flat top adapter.

FIG. 6 is a component block diagram of a charging dock.

FIG. 7 is another component block diagram of a charging dock.

FIG. 8 is another component block diagram of a charging dock.

FIG. 9 is a component block diagram of a charging dock with an internal battery pack.

### DETAILED DESCRIPTION

In accordance with an embodiment of the present invention, described herein is a charging dock that can receive one or more portable electronic devices at the dock, without cords, and yet provides high flexibility by using user-interchangeable charging adapters. The adapters provide the interconnect between portable electronic devices with various charging ports, and the charging dock.

In accordance with an embodiment, a charging dock comprises of a power supply that provides power either from a household power outlet or from a battery-based power pack, a logical unit that can be implemented with an integrated circuit (IC) board, and a number of dock connectors. Each charging connector can be placed inside a cavity on a surface of the charging dock.

In accordance with an embodiment, the charging connectors are fixed on the charging dock. A charging adapter can be fitted on the charging connector so that the charging dock may receive different types of portable electronic devices by swapping out the adapters.

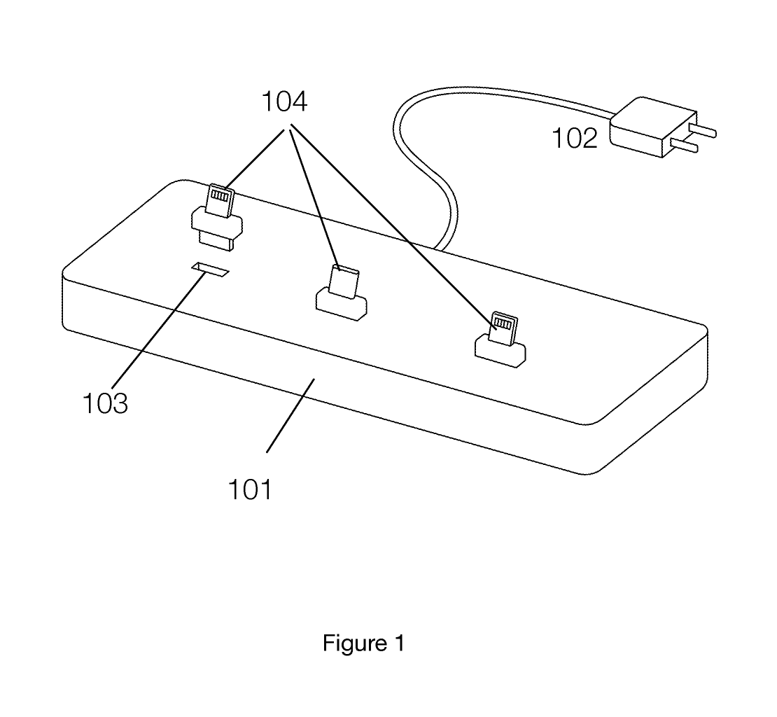

FIG. 1 illustrates an overall view of a charging dock with interchangeable adapters, in accordance with an embodiment of the invention. As shown, a charging dock can have a base unit 101. The base unit can have a power plug 102 which receives power from a household power outlet. An AC/DC power converter can be housed inside the base unit. The base unit can have one or more cavities 103. Charging adapters 104 can be inserted into the cavities.

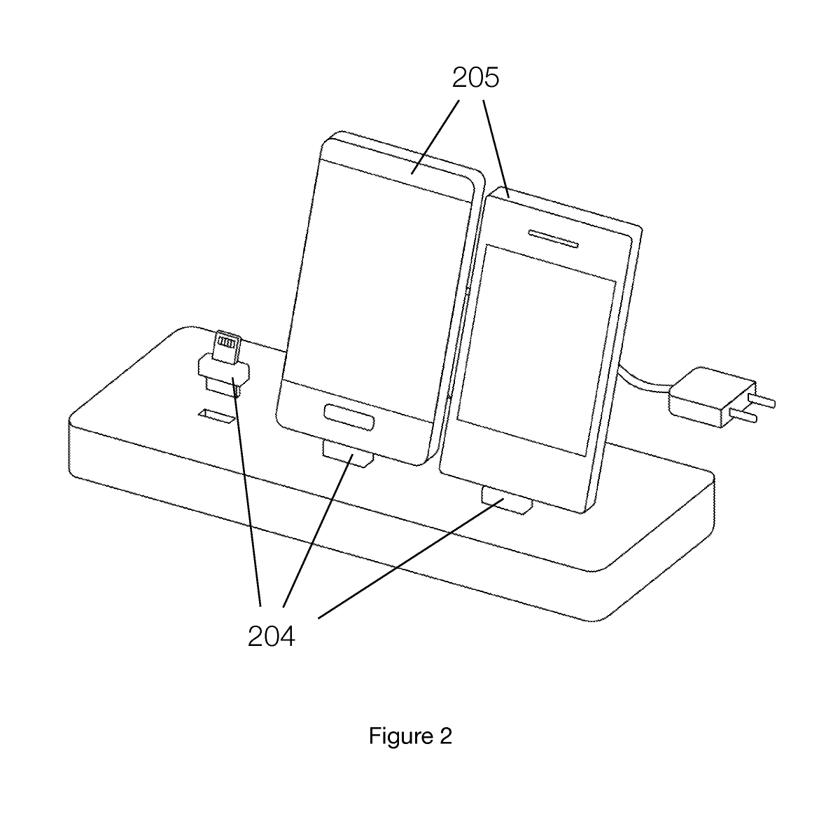

FIG. 2 illustrates a charging dock, in accordance with an embodiment of the present invention. A number of mobile devices 205 can be placed on the charging adapters 204.

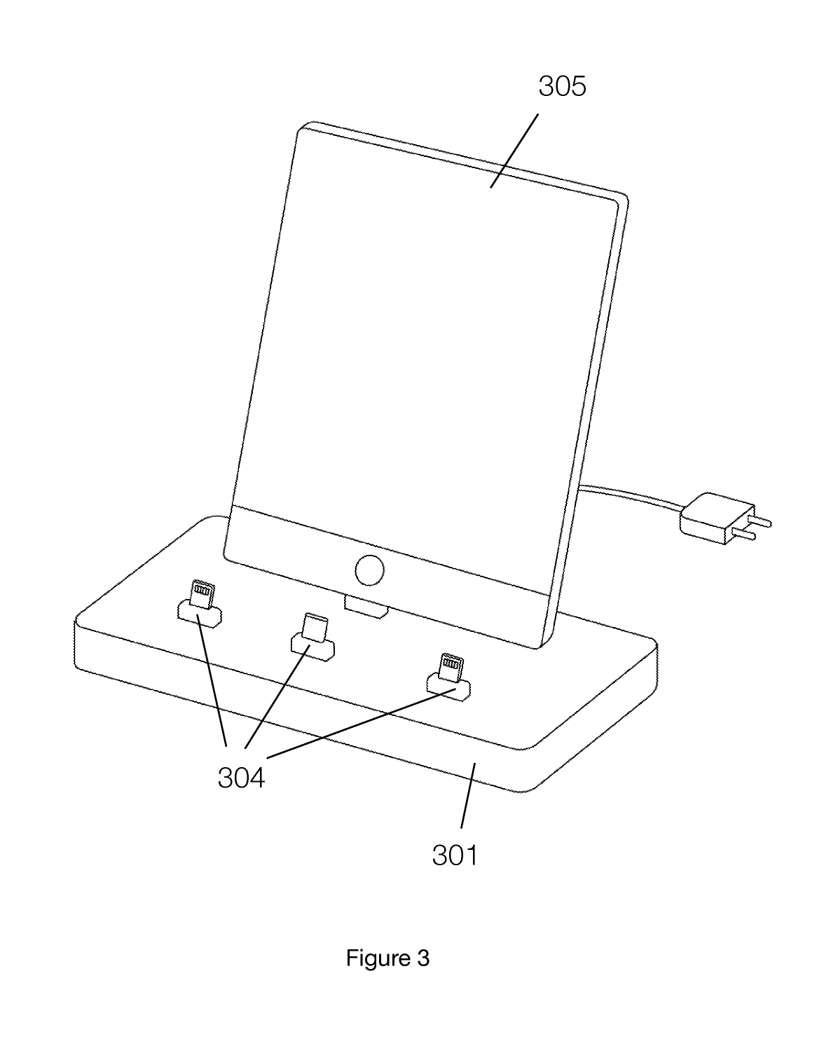

FIG. 3 illustrates a charging dock, in accordance with an embodiment of the present invention. As shown, a larger mobile device 305 can be placed on the charging dock, without hindering access to other charging adapters 304.

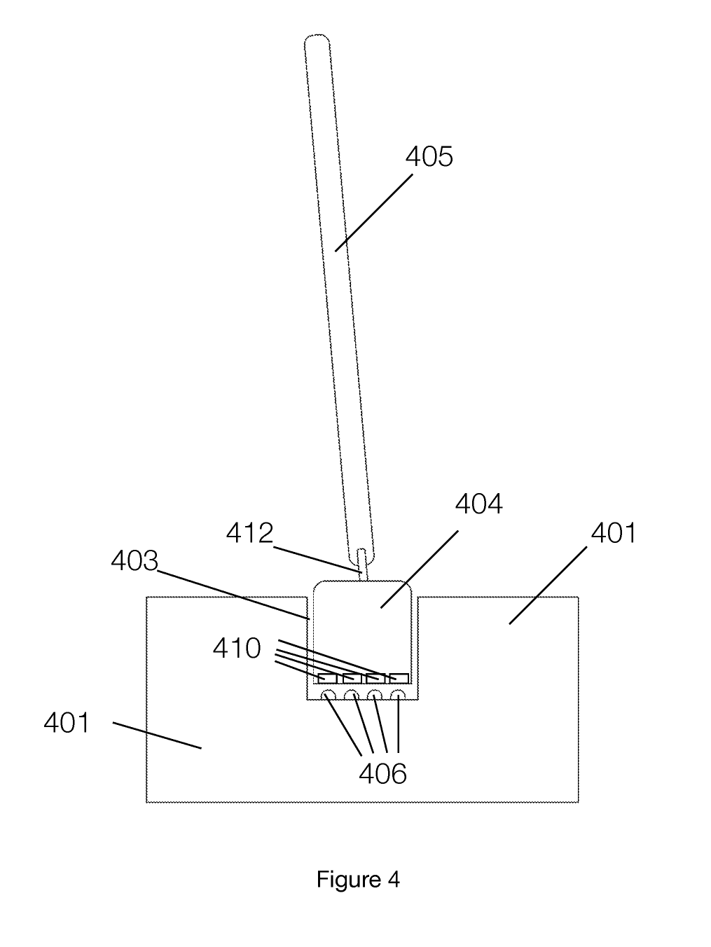

FIG. 4 illustrates a cross-section of a charging dock, in accordance with an embodiment of the present invention. As shown, a portable device 405 can be placed on the charging dock 401 via an interchangeable charging adapter 404, which can be snugly inserted into the cavity 403. A number of electrical contacts 406 can be placed inside the cavity, which provides power and communication channels to the mobile device via the adapter. The contacts can be attached at base unit by molding, welding, gluing, mechanically holding, or any other common methods in the industry. These contacts can make physical contact with a dock-to-adapter connector 410 at the adapter. On the other side of the adapter, a portable device charging connector 412 can be inserted into a charging port at the portable device.

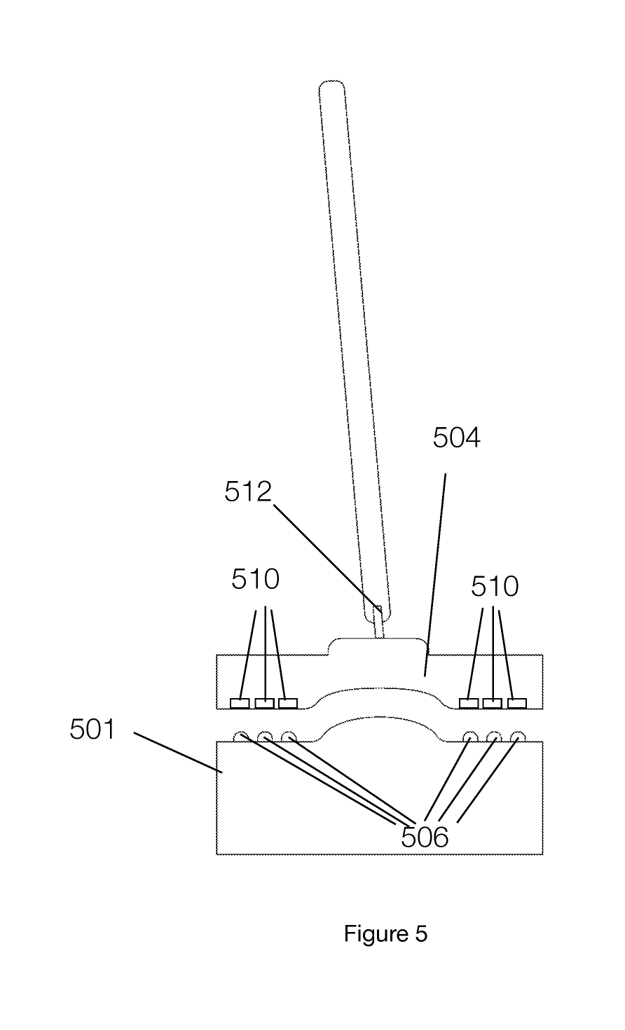

FIG. 5 illustrates a cross-section of a charging dock, in accordance with another embodiment of the present invention. As shown, the charging adapter 504 can be placed directly on top of a charging dock base unit 501. A number of electrical contacts 506 can come into contacts with dock-to-adapter connectors 510 to form electrical connections. Portable electronic devices can then be placed on the adapter, wherein the portable device charging connector 512 is inserted into charging ports at the portable devices.

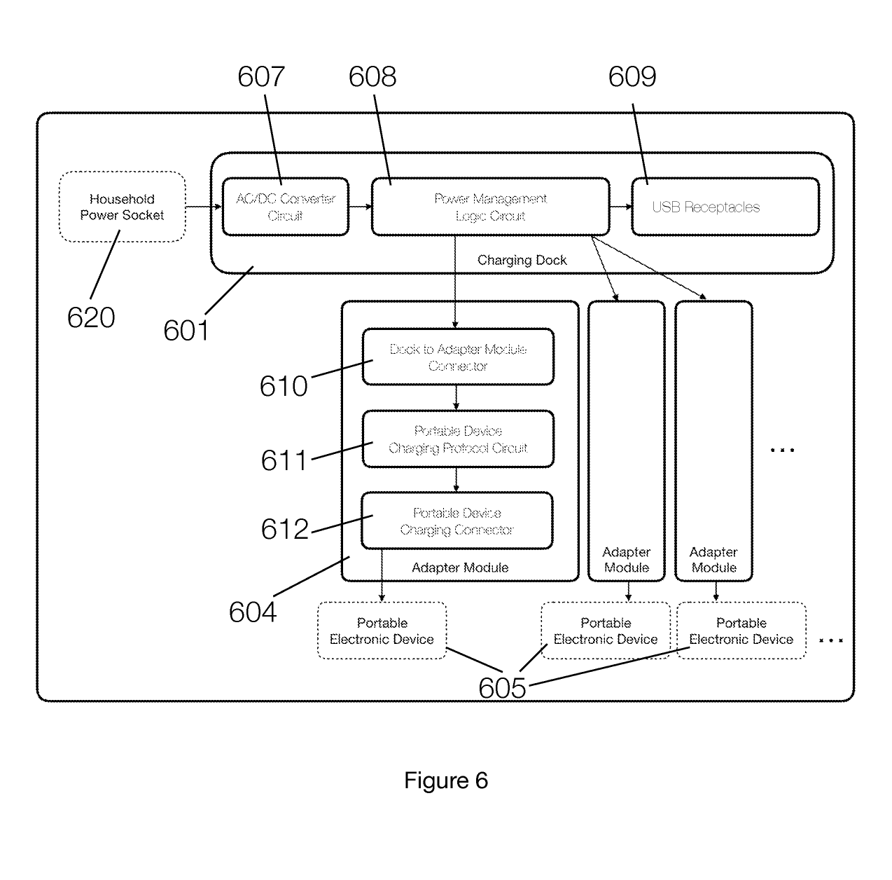

FIG. 6 illustrates a block diagram of the components of a charging dock, in accordance with an embodiment of the present invention. As shown, the charging dock base unit 601 can be plugged into a household power socket 620. The power is converted from alternating current (AC) into direct current (DC) via an AC/DC converter 607. The direct current can power a power management logic circuit 608.

The power management logic circuit evaluates total power available from the AC/DC Converter Circuit, versus the power needed at each adapter or adapter module 604 and at each USB receptacle 609, then provides the optimal charging power to each adapter module or USB receptacle. The power management logic circuit can also provide safety protection by detecting a trigger event such as an electric short, spike, surge, or overload within any connected module, and then shuts down power if needed.

Portable devices 605 can be placed on the adapter modules. A number of USB receptacles 609 can also be placed on the charging dock, providing the functionality of a USB “hub”, wherein a user may insert USB charging cords into these receptacles for corded charging.

Each adapter module can comprise a dock-to-adapter connector 610, a portable device charging protocol circuit 611, and a portable device charging connector 612. The dock-to-adpter connector makes physical contact and the necessary connections with the base unit.

The portable device charging protocol circuit can communicate with connected portable electronic devices to exchange device identity of the charging dock and/or the portable devices, charging capability, charging status, charging request information, and other information to facilitate charging. This circuit can also pass charging power from the dock into the portable devices.

The portable device charging connector makes physical contact and the necessary connections with a charging port of portable electronic devices.

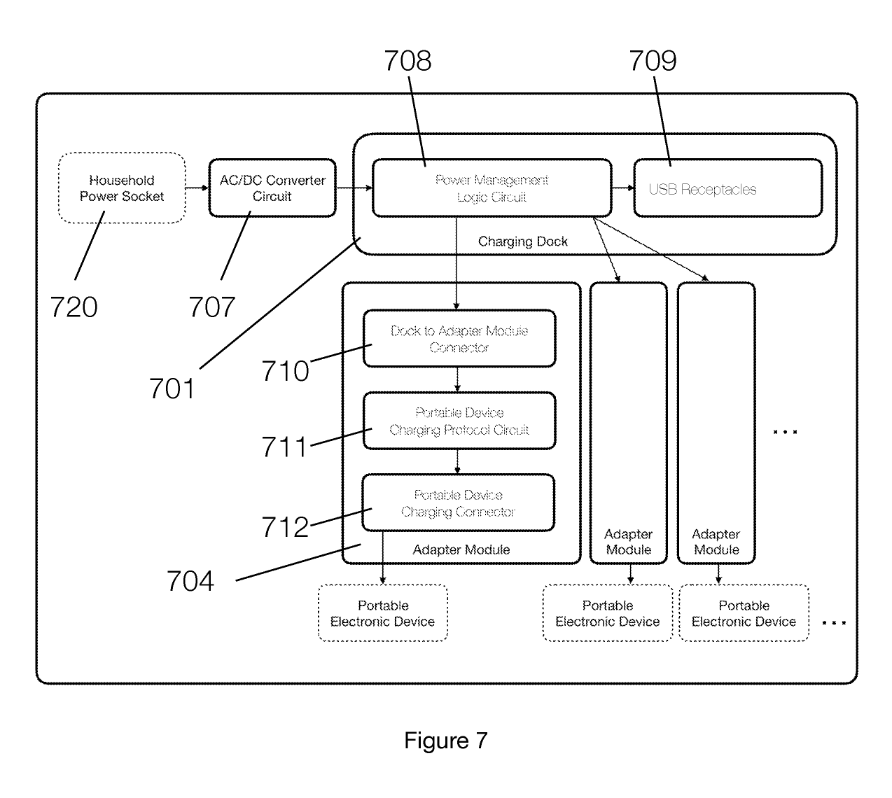

FIG. 7 illustrates a block diagram of the components of a charging dock, in accordance with another embodiment of the present invention. The AC/DC converter 707 is an external to the charging dock 701. A power cord can provide the power connection between the AC/DC converter and the charging dock.

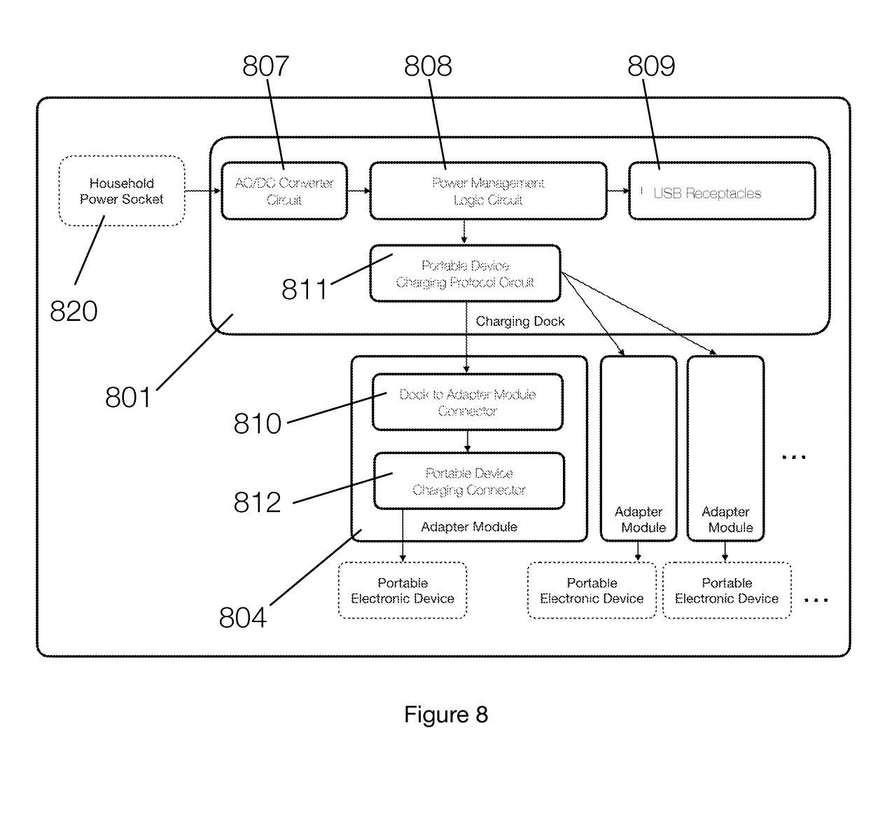

FIG. 8 illustrates a block diagram of the components of a charging dock, in accordance with another embodiment of the present invention. As shown, the portable device charging protocol circuit 811 is housed inside the charging dock base unit 801. The portable device charging protocol circuit can be part of the power management logic circuit 808. The two circuits can form a single logical unit.

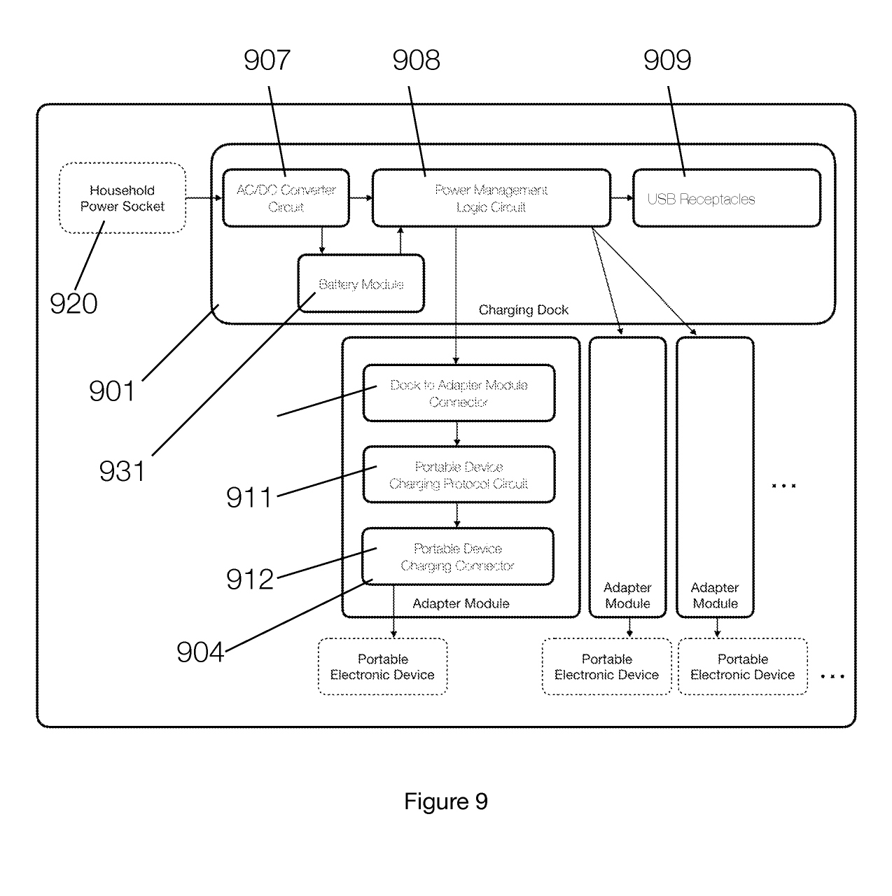

FIG. 9 illustrates a block diagram of the components of a charging dock, in accordance with another embodiment of the present invention. As shown, charging dock base unit 901 can further comprise a battery module 931, which can be charged when the dock is plugged into a power plug 920, and provide power to the charging dock when the dock is unplugged from the power plug.

In accordance with an embodiment of the present invention, the charging adapters can be held in their respective cavities by friction. The dimensions of the adapters can be made so that the adapters can snugly fit within the cavities.

In accordance with another embodiment of the present invention, the charging adapters can be held in their respective cavities through magnetism. Magnets can be placed within the base unit, the adapters, or both. In the case where magnets are only placed within the base unit, or the adapters, ferrous metals can be placed within the other component.

In accordance with another embodiment of the present invention, the charging adapters can be held in their respective cavities via a mechanical locking mechanism, such as a spring-loaded locking pin, a twist lock, or a latch.

In accordance with an embodiment of the present invention, the charging adapters protrude from a surface, such as a top surface, of the base unit, thus providing quick coupling with a portable device for the users.

Embodiments of the present invention may be conveniently manufactured using one or more conventional general purpose or specialized processes. Appropriate hardware and software coding can readily be prepared by skilled persons based on the teachings of the present disclosure, as will be apparent to those skilled in the art.

The foregoing description of embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated.

What is claimed is:

1. A charging dock for charging one or more portable electronic devices, said charging dock comprising:
a power supply;
a base unit, comprising
a logical circuit, receiving power from the power supply and configured to calculate optimal charging power, and
a plurality of electrical contacts, electrically connected to the logical circuit; and
one or more adapters, each comprising a dock-to-adapter connector and a device connector, wherein
the dock-to-adapter connector is configured to make contact with and receive electrical power from one or more of the electrical contacts at the base unit, and
the device connector is configured to plug into and provide charging power to at least one of the portable electronic devices.

2. The charging dock of claim 1, where in the power supply is configured to connect into an alternating current (AC) household power outlet and outputs direct current (DC) power.

3. The charging dock of claim 2, wherein the power supply is an internal component of the charging dock.

4. The charging dock of claim 2, wherein the power supply is an external component of the charging dock.

5. The charging dock of claim 1, where in the power supply is a rechargeable power pack.

6. The charging dock of claim 1, wherein the base unit further comprises a portable device charging protocol circuit, configured to regulate charging for one or more charging protocols.

7. The charging dock of claim 6, wherein the charging protocol circuit is enclosed in the base unit.

8. The charging dock of claim 6, wherein the charging protocol circuit is enclosed in one of the adapters.

9. The charging dock of claim 1, the base unit further comprising one or more cavities on an outer surface, wherein
the electrical contacts are placed within the cavities, and
the adapters are configured to fit within the cavities.

10. The charging dock of claim 1, further comprising one or more USB charging receptacles at an outer surface of the base unit, the USB charging receptacles being configured to receive one or more USB charging cables.

11. A method for charging one or more portable electronic devices, comprising:
providing electrical power to a base unit via a power supply, the base unit comprising
a logical circuit, receiving power from the power supply and configured to calculate optimal charging power, and
a plurality of electrical contacts, electrically connected to the logical circuit; and
plugging an adapter, comprising a dock-to-adapter connector and a device connector, to the base unit;
configuring the dock-to-adapter connector to make contact with and receive electrical power from one or more of the electrical contacts at the base unit; and
plugging at least one of the portable electronic devices, at a charging port of the portable electronic device, into the device connector wherein charging power is provided to the plugged-in portable electronic devices.

12. The method of claim 11, where in the power supply is configured to connect into an alternating current (AC) household power outlet and outputs direct current (DC) power.

13. The method of claim 12, wherein the power supply is an internal component of the charging dock.

14. The method of claim 12, wherein the power supply is an external component of the charging dock.

15. The method of claim 11, wherein the power supply is a rechargeable power pack.

16. The method of claim 11, wherein the base unit further comprises a portable device charging protocol circuit, configured to regulate charging for one or more charging protocols.

17. The method of claim 16, wherein the charging protocol circuit is enclosed in the base unit.

18. The method of claim 16, wherein the charging protocol circuit is enclosed in one of the adapters.

19. The method of claim 11, further comprising:
providing one or more cavities on an outer surface at the base unit;
attaching the electrical contacts to the base unit within the cavities; and
fitting the adapters within the cavities.

20. The method of claim 11, further comprising providing one or more USB charging receptacles at an outer surface of the base unit, and configuring the USB charging receptacles to receive one or more USB charging cables.
